(19) United States
(12) Patent Application Publication
(10) Pub. No.: US 2010/0032956 A1
(43) Pub. Date: Feb. 11, 2010

(54) SYSTEM AND METHOD FOR HARNESSING WIND POWER AT VARIABLE ALTITUDES

(75) Inventors: Craig Varrichio, Round Rock, TX (US); Mark Landry, Austin, TX (US); Anthony Varrichio, Plano, TX (US)

Correspondence Address: HULSEY IP INTELLECTUAL PROPERTY LAWYERS, P.C., 919 Congress Avenue, Suite 919, AUSTIN, TX, 78701, US

(73) Assignee: CMNA POWER, Austin, TX (US)

(21) Appl. No.: 12/188,867

(22) Filed: Aug. 8, 2008

(51) Int. Cl. F03D 5/00

(52) U.S. Cl. 290/55

(57) ABSTRACT

A system for harnessing power from wind using a wind capturing structure. An axis of rotation could be central to the system, and the lines could rotate around this axis. Features for the wind capturing structure include effective downwind power generation using a durable, lightweight, inexpensive structure that may be safe in the event of a crash, and easily modified to reduce drag for retraction. The capturing structure creates lift in a low altitude environment, capable of operating in high wind conditions. The lines include minimal mass to permit lift at low altitudes, and are constructed with maximum tensile strength to prevent failure in high winds. A versatile wind capturing structure could include a kite operable in variable conditions for efficient and consistent production of force. The power producing cycle of a system capturing power from wind should maximize the efficiency of the system.

### TECHNICAL FIELD OF THE INVENTION

The present invention relates to devices that produce useful power from wind energy—more specifically to devices that extract power using tethered kites and a generator.

### DESCRIPTION OF THE RELATED ART

The kite is a very old technology, and has been used for centuries as entertainment and as a common toy. More recently, kites have been used to help tow many different types of vehicles, from skateboards and surfboards to boats.

Typically kites are used close to the ground, and are controlled by multiple lines operated by one person. This environment has variable wind conditions, as well as inconsistent direction and intensity. The environment near the ground is not financially and operationally practical for sustainable and effective power production.

A basic reason a kite system may be operationally impractical in an environment away from the ground is that the materials used to manufacture the kites have developed slowly. Combining new materials and techniques with old technologies to construct kites capable of larger drag and tensile forces may be needed to progress this technology. With new materials the kites could be operated in more extreme environmental conditions as well as further away from the surface, thereby increasing production. Kite system safety measures are another area where development has been slow. A kite elevated in the atmosphere could be an obvious discharge point for lightning and static electricity. Anchoring a kite that is in extreme wind conditions also requires attention. Broken lines and lost kites are not only expensive, but may be dangerous.

Related art, such as U.S. Pat. No. 3,924,827, entitled “APPARATUS FOR EXTRACTING ENERGY FROM WINDS AT SIGNIFICANT HEIGHT ABOVE THE SURFACE” and U.S. Pat. No. 4,076,190, entitled “APPARATUS FOR EXTRACTING ENERGY FROM WINDS AT A SIGNIFICANT HEIGHT ABOVE THE SURFACE” by Lambros, U.S. Pat. No. 4,124,182, entitled “WIND DRIVEN ENERGY SYSTEM” by Loeb, U.S. Pat. No. 6,254,034, entitled “TETHERED AIRCRAFT SYSTEM FOR GATHERING ENERGY FROM WIND” by Carpenter, U.S. Pat. No. 6,523,781, entitled “AXIAL-MODE LINEAR WIND-TURBINE” by Ragner, and U.S. Pat. No. 7,188,808, entitled “AERIAL WIND POWER GENERATION SYSTEM AND METHOD” by Olson all describe methods of capturing wind using an elevated device. Inherently each disclosure is also very complicated and not functional in producing efficient power.

There is a need for a wind power system and method of operation that allow financially and operationally practical use of such systems for sustainable and effective power production at variable altitudes.

A further need exists for kites and kite systems employing materials that allow their operation in more extreme environmental conditions to support the sustainable and effective generation of electrical power through wind energy conversion processes.

A further need exists for a kite system and methods of their operation that are electrically and mechanically safer than known kite systems.

### SUMMARY

The presently disclosed subject matter includes a system and methods of operation of said system for generating electrical power from wind using a wind capturing structure lofted into faster wind currents. An exemplary embodiment could have a wind capturing structure for creating a force operable over a wind range of 2 m/sec to 20 m/sec, and lines of at least 250 kN*m/kg strength to density ratio attached to the wind capturing structure. The preferred embodiment may be operated over any wind speed, and may be calibrated to maximum operation particular to the location. The lines could be let out, generating linear motion. An axis of rotation could be central to the system, and the lines could rotate in any direction (depending on the wind) around this axis. A winding structure on the axis of rotation could be used to wind the lines and for transforming the linear motion into rotational motion. A retractor attached to the winding structure could be used to rewind the lines from one predetermined length to a second predetermined length of shorter magnitude. Finally, a generator could be coupled to the winding structure for converting the rotational motion into electrical power.

Preferred features for the wind capturing structure may include being effective in downwind power generation, durable in high winds, lightweight, inexpensive, safe in the event of a crash, and easily modified to reduce drag for retraction.

In a preferred embodiment, the wind capturing structure may be a kite; a sparless kite, a bridleless kite, a single skin kite, a parawing kite, a sail wing kite, a Rogallo kite, a low line angle kite, a high angle of attack kite, a low lift/drag ratio kite are all possible kites that could be used in the system, but new developments may also be better options. The capturing structure may be capable of creating lift in a low altitude environment, and capable of operating in high wind conditions.

An exemplary embodiment may have a minimum plurality of lines with a strength to density ratio of at least 250 kN*m/kg, which may be constructed of carbon nanotubes, carbon fiber, Ultra High Molecular Weight Polyethylene (UHMWPE) synthetic rope, Cuben Fiber, Plasma®, PBO, Kevlar®, Aramid®, M5®, Zylon®, braid optimized for bending (BOB), a hybrid rope, which all have been shown to have high specific strengths. The lines are constructed with minimal mass to permit lift of said wind capturing structure at low altitudes, and are constructed with maximum tensile strength to prevent failure in high wind environments. In a preferred embodiment, the lines that control the wind capturing structure could not slip on the spool during normal operation.

The winding structure may be a spool, spindle, reel, coil, or any structure capable of rotating about an axis. The preferred embodiment could also minimize energy losses in the system for maximum efficiency.

A versatile wind capturing structure could include a kite operable in variable conditions for efficient and consistent production of the force, lines with a minimum tensile strength to density ratio 250 kN*m/kg for linear motion generation, a velocity controller for controlling the rotational motion and the linear motion, and drag coefficient controller for adapting the kite's drag coefficient and/or cross-sectional area (also referred to as “reference” area) for optimizing power output and/or input. The versatile wind capturing structure may be adaptable by drag coefficient and velocity controller. Control via the lines allows for the entire system to be efficient and consistently generate force for power production. An exemplary embodiment of velocity control may be accomplished by altering a load upon a generator. Similarly the velocity could be controlled by altering the drag force of the wind capturing structure. Altering the drag force could be accomplished by folding, deforming, re-orienting, or some other means of reducing drag on the wind capturing structure.

The power producing cycle of a system generating electrical power from wind has the steps of unwinding the winding structure to create linear motion for producing rotational motion, coupling the winding structure to a generator for power production, slowing down the linear motion, reducing the drag for retrieval, altering the winding structure to operate in reverse for retrieving the system, and starting the cycle again. The retrieval energy used should be kept to a minimum to maximize the efficiency of the system.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages included within this description be within the scope of the accompanying claims.

### BRIEF DESCRIPTION OF THE DRAWINGS

For a more complete understanding of the features and advantages of the present disclosure, reference is now made to the detailed description of the invention along with the accompanying figures in which corresponding numerals in the different FIGUREs refer to corresponding parts and in which:

FIG. 1 is a diagram of the forces which act upon a kite system in flight;

FIG. 2 is a diagram of one embodiment of the present disclosure, showing the different components;

FIG. 3 is a diagram of one embodiment of the present disclosure showing a more intricate view of several components; and

FIGS. 4A and 4B are diagrams of one embodiment of the present disclosure transitioning from extraction to retraction.

### DETAILED DESCRIPTION

While making and using various embodiments of the present disclosure are discussed in detail below, it should be appreciated that a preferred embodiment provides many applicable inventive concepts, which may be embodied in a wide variety of specific contexts. The specific embodiments discussed herein are merely illustrative of specific ways to make and use the present disclosure and do not delimit the scope of the present disclosure.

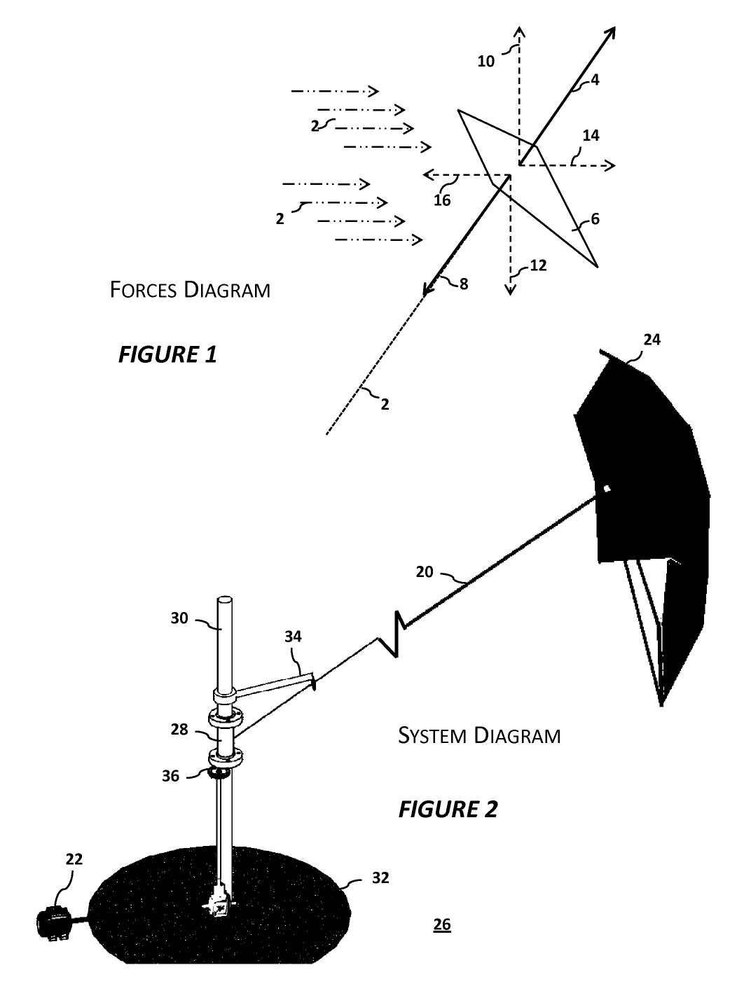

The present disclosure involves using a wind capturing structure (a kite) to power a system that produces electrical energy in the most simple and efficient way. FIG. 1 shows that the system relies on wind 2 causing wind force 4 on kite 6. Kite 6 remains in flight by flying at an angle to the anchor (in recreational kites, the anchor may be the user); wind force 4 occurs in the opposite direction of the anchoring line 8. To be effective, wind force 4 must create enough force that vertical wind force component 10, referred to as “lift” is equal to or greater than downward force component of the line 12 plus the weight of the kite 6. Normally, horizontal wind force component 14, referred to as “drag”, cancels with the horizontal force of the line 16 (equal and opposite in direction), and the kite may be stationary. However, in the power generating system, drag 14 may be still equal to the horizontal line force during the outbound phase, but the system allows motion to be generated. Force 4 decreases during the inbound phase, which also decreases force 8 making retraction easier.

For a moving kite, line tension (rope tension) may be equal to power generated divided by the outbound kite speed. For a stationary kite, rope tension may be equal to lift plus drag, which may be equal to one to two times the drag force while line angle is between 0° and 45°. Drag may be equal to 0.5*Air density (1.2)*velocity²*kite area*drag coefficient (about 1.42 for a Rogallo kite)

F_{drag}=½*ρₐᵢᵣ*u²*Aₖᵢₜₑ*C_{d}

C_{d}≈1.42

ρₐᵢᵣ≈1.2

where,

ρₐᵢᵣ=Density of Air

Aₖᵢₜₑ=Area of Kite

F_{drag}=Drag Force

At a 45 degree line angle, lift force≈drag. Therefore, roughly, this number must exceed the weight of the kite and extended rope to stay aloft. A lightweight rope would be ideal, however, the same rope must be strong enough to harness the higher wind speeds. The combined vectors of the two equal forces acting parallel to the line may be equal to √2/2*drag. This gives equations (1) and (2) providing the minimum necessary strength to weight characteristics of the rope:
(1) Tensile strength*cross sectional rope area>√2/2*0.5*1.2*VMax̂2*reference area*1.42
(2) gₙ*Rope density*cross sectional area*length<0.5*1.2*VMin̂2*reference area*1.42

Solving for strength to weight ratio, or specific strength, of the line gives:

Tensile Strength(N/m̂2)/Density(kg/m̂3)>1.414213562*Total Length (m)*9.80665(m/ŝ2))*(Maximum wind speed(m/s)̂2/Minimum wind speed(m/s)̂2)

or

σ_{UTS}[N/m²]/ρ[kg/m³]>√2*gₙ[m/s²]*L[m]*uₘₐₓ²[m/sec²]/uₘᵢₙ²[m/sec²]

where,

σ_{UTS}=Tensile Strength

gₙ=Standard gravity

u=Wind Velocity

Likewise, the minimum wind speed in which a given rope may be used to keep a kite aloft is: Minimum wind speed=√(√2*((Rope weight+kite weight)*Maximum wind speed²)/Breaking Strength):

uₘᵢₙ=√(√2*(Wᵣₒₚₑ+Wₖᵢₜₑ)*(uₘₐₓ²)/σ_{BS})

where,

Wᵣₒₚₑ=Rope Weight

Wₖᵢₜₑ=Kite Weight

σ_{BS}=Breaking Strength

In many areas, wind speed increases significantly upon reaching an altitude of 300 m. Since line angle is assumed to be approximately 45°, this gives a line length of 300/(sin 45°)=424.26 m. In order to not involuntarily fall from this minimum wind window, the kite must be able to stay aloft in the minimum winds typical for this altitude. A liberal estimate is 3 m/s.

Kite performance increases with a higher peak wind speed harnessed. For optimal performance, the particular maximum wind speed may be at least 20 m/s. To operate under these conditions requires a rope with a specific strength of:

$$\begin{matrix} = √ 2 * 424.264068 [ m ] * {9.80665 [ m \text{/} s ]}^{2} * \\ ( {( 20 [ m \text{/} sec ] )}^{2} / {( 3 [ m \text{/} sec ] )}^{2} ) \\ = 261 , 511 N * m \text{/} kg\end{matrix}$$

A wind power generation system includes a kite that moves outbound for a distance semi-parallel to the ground, then may be retracted for a distance using less force, and then cycles to outbound movement again. Energy may be generated on the outbound stage. During the inbound, or retraction, phase the kite may be made to use less force by either modifying the position, modifying the shape or aerodynamic properties, or by using lift to fly back inwards. The modification of the kite during this phase may be accomplished by either a remote signal to a device on the kite, a secondary signal rope, a secondary main rope, a signal sent up the main rope (such as a tug), or an automatic detection by a device on the kite.

FIG. 2 shows kite electrical power system consisting of single rope 20 that turns generator 22, attached to kite 24 moving at a low angle from ground 26. Kite 24 may be one that maximizes lift+drag per surface area, with the only lift requirement that the kite generates enough during the outbound and inbound states to stay aloft.

Rope 20 may be attached to spool 28 on robust vertical axle 30 fixed in concrete ground anchor 32, vertical axle 30 and ground anchor 32 are not affected by wind direction. This spool 28 allows 360 degrees of operation of kite 24. Separate guide 34, which rotates independently around the axle above the spool, keeps the string properly aligned on the spool and may prevent slippage.

Beveled gearing system 36 connects spool 28 to detached generator 22. Gearings system 36 includes safety measures so that a failure along spool 28 may not damage generator 22.

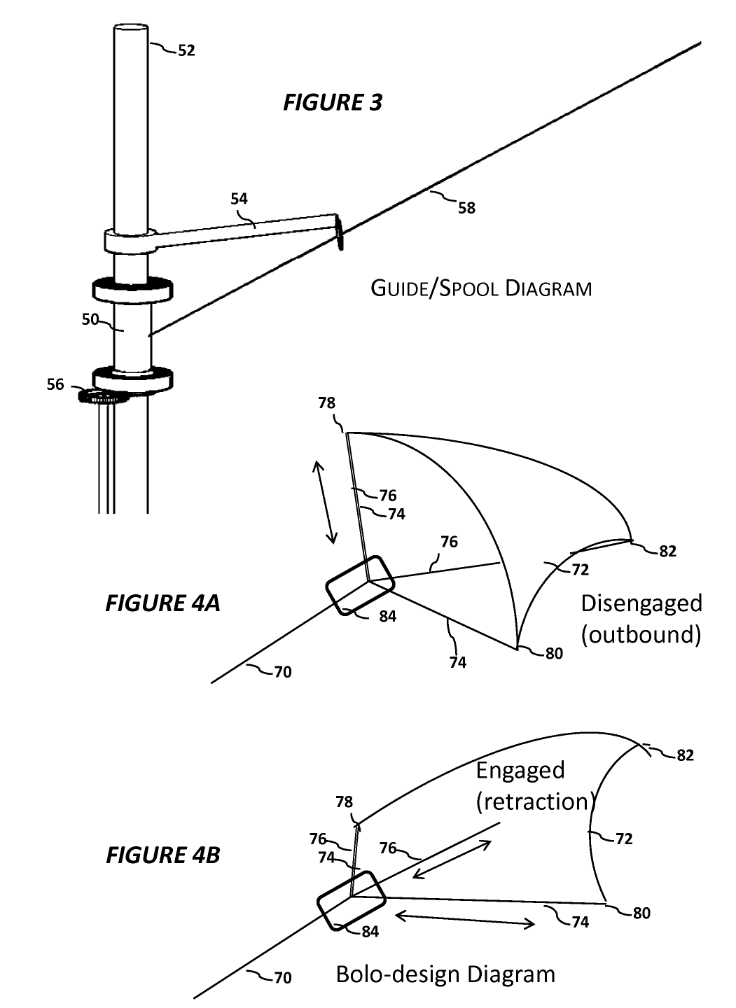

A more intricate figure of this embodiment is shown in FIG. 3. Spool 50 may be on central axis 52. Axis 52 may be vertical so that the wind may change direction without affecting the system's operation. Guide 54 also rotates according the wind direction, and aids in the successful winding and unwinding of spool 50. Finally, the start of gearing system 56 may be below spool 50. Although gearing system 56 may not rotate around axis 52, it may be unaffected by wind direction. Gearing system 56 may have multiple functions including, but not limited to, supplying the rotational motion to the generator, insulating critical components from static and electrical spikes, simplifying maintenance, and may be used in reversing the system, and/or continuous variability to control rotation speed.

The system may further include a clutch coupled to the gearing system. The clutch could be able to transition the winding structure into a retracting phase. Also, a flywheel may be included. The flywheel could be capable of absorbing excess energy and momentum. Momentum could be conserved, and energy may be stored mechanically in the events of excess energy, such as gusting conditions, or high winds. The clutch could engage the flywheel when necessary, both to absorb energy and to return energy to the system if it was needed.

FIGS. 4A and 4B show mainline string 70 attached to the bridle of kite 72, which consists of two lines 74 and 76 joined at single point 78 at the top of the kite, and two separate points 80 and 82 at either side of the bottom of the kite. The mainline wraps around the two bridle lines with sheath 84; sheath 84 may be able to slide up and down the bridle lines 74 and 76 like a bolo. A locking spring-loaded mechanism exists on either side of the sliding sheath 84. While outbound, upon receiving a sudden jerk from the mainline, the mechanisms unlock and the springs attempt to slide the sheath upwards along the bridle. The bole layout may naturally force the mechanisms and sheath upwards, which changes the “center of force” on the kite from the middle of the curved surface to a position more to the front. This flattens the kite, largely reducing the drag. The mechanism may store spring energy, possibly in a torsion spring, on the upwards trip. Once at the top of the kite, the kite may flatten out and retract easily. Once retracted, tension may be let up on the rope, and the spring mechanisms slides the sheath downward along the bridle. This may pull the kite back into position for outbound travel by shaping the kite aerodynamically.

The bolo configuration may also force the sheath to slip upwards if the force on the system exceeds a certain threshold. This may happen automatically after wind speed reaches a certain level. Other possible mechanisms used in the sheath include but are not limited to compressed air, pistons and/or motors.

Kite angle may be another contributing factor to force generation. Typically, kites are designed to fly at as high an angle as possible; however the present disclosure may utilize kites that fly at lower angles. The horizontal drag force, referenced as “drag”, becomes larger as the angle decreases from 90° (straight up) to 0°. Equal lift and horizontal force produce a line angle of approximately 45°. An optimal operating line angle may be slightly less than 45° from the horizontal axis in an exemplary embodiment.

The true optimization equation for line angle may be a complicated equation involving integrating the wind power over the altitude range of operation. However, assuming approximately equivalent speeds over the entire range, the efficiency equation maximizes at the lowest possible line angle. Other extensions of this optimization take into account rope cost versus increased efficiency cost.

Lₗᵢₙₑ=Height/sin(θₗᵢₙₑ)

A decrease in line angle results in an increase of rope length of:

Range/sin(θ_{line[1]})−Range/sin(θ_{line[2]})

To accomplish flight at a varying angle, the bridle lines need to be altered. Flight at a low angle may produce a higher force from lift+drag, and the path of flight may be lengthened, minimizing the effect or ratio of “time lost” when flipping the kite.

Decreasing line angle also has a correlation with increasing the angle of attack. Increasing the angle of attack will typically increase the reference area of the kite, further increasing the total force generated on the kite.

Finally, the drag coefficient and the effective area of the kite may determine how much force may be generated as a function of the wind speed squared, and the density of the fluid (in this case atmospheric air). The drag coefficient may be determined by the shape, rigidity, permeability and orientation of the kite relative to the flow. Altering this coefficient, with methods such as the previously mentioned bolo, may also determine how much energy may be required to retract the structure back to its starting point. The system should minimize drag while maintaining flight during this phase for maximum efficiency in the overall system.

Additional methods to reduce the drag include folding, and re-orienting the kite so that it presents new features in this different state. Folding the kite again may reduce the cross sectional area that may be exposed to the flow.

Re-orienting the kite changes the profile of the kite with relation to the flow. This may alter the drag and lift coefficients. With the correct profile pointed into the flow, the kite may move at an angle in to the flow. This may be similar to a sail boat that uses the airfoil to drive the boat. A sail boat may be driven in any direction with the exception of 45° of directly into the wind, leaving 270° of available tacking direction. Moving angularly to the flow could significantly reduce the required energy to retrieve the wind capturing structure.

The kite travels back and forth between an optimized minimum (for example 300 meters) and a maximum (for example 400 meters) in a flat rural area, complying with any regulations for the airspace for that region, but operating in a local maximum for wind speed and consistency. Wind speeds and consistency are variable according to location, but the system may be optimized based on the chosen location. The same criteria may be used for any night time drop off in winds. The system may be designed to maximize efficiency over the entire year, as well as minimize potential “crash events”. Outbound travel time and speed may be a function of wind speed. Inbound speed may be largely constant at 20 m/sec or more.

Efficiency of the system may be measured using the following equation. Efficiency=(time generating/(time generating+time retracting+time transitioning))*((energy generated−energy consumed)/(energy generated)). For example, 30 seconds of outbound motion yields 1000 joules of energy; then, 30 seconds of retraction requires 500 joules of energy. Efficiency may equal (30/60)*((1000−500)/1000), yielding an efficiency of 0.25.

Eff=(tᵤₚ/(tᵤₚ+t_{down}))*((Eᵤₚ−E_{down})/(Eᵤₚ))

where,

tᵤₚ=Time spent in upward flight (extension)

t_{down}=Time spent in downward flight (retraction)

Eff=System efficiency

Eᵤₚ=Energy in upward flight

E_{down}=Energy in downward flight

In an exemplary embodiment, the kite flies from 300 meters to 400 meters at an angle of 30°. The total distance traversed may then be 183 meters (182.88). At a wind speed of 10 m/sec, the kite may move outwards at 5 m/sec, taking it 36.576 seconds to travel the entire distance. A generous ceiling for kite flattening time may be the time it could take the tail of the kite, moving in an arc, to travel to be parallel with the wind. If the height of the kite may be 30 meters, the arc may be approximately equal to ¼*(π*2*30 meters)=¼*188.5=47 meters. At 10 m/sec, this may be equal to 4.7 seconds. This time may be exaggerated; the present embodiment could take much less time. At the end of the retraction phase, the front end of the kite must again move to be perpendicular to the wind, which should take the same amount of time, another 4.7 seconds. If the kite were retracted at 10 m/sec, this could take 18.288 seconds. Thus the total time during retraction may be 27.688 seconds, giving a maximum efficiency of 57%.

Outbound speed and rope tension are inversely related. Both are varied automatically to maintain the optimal angle and maximize the fluid dynamics equation for kite speed vs. wind speed. Rope tension may be controlled at the generator level by varying generator load.

Expended rope and line angle may be monitored. The system automatically retracts based on a combination of these factors indicating reaching the ceiling, or cycle time, or upon line termination. The kite may be also automatically retracted if rope tension falls below a certain threshold.

Kite power may be made difficult by the need to be able to withstand strong winds at higher altitudes while being lightweight enough to create lift in lighter conditions and to be lightweight enough to be launched in the lower wind conditions of lower altitudes. The limiting factor currently in this system may be rope weight, not kite weight. The minimum for practical use of a kite power system in most areas may be a specific strength (tensile strength/density ratio) of approximately 250,000 (N*m/kg).

Materials such as carbon nanotubes, carbon fiber, UHMWPE synthetic rope, Cuben Fiber, Plasma, PBO, Kevlar, Aramid, M5, Zylon, and braids may be used to construct the rope in the present disclosure. An exemplary UHMWPE rope made of Spectra has a specific strength of 1,380,000 N*m/kg, which satisfies the requirements of the system.

The anchoring platform for the system may be very robust. It may need to be constructed to withstand the forces, moments, and stresses produced by the kite. Generator size per meter of kite collection area may be an optimization problem based on wind power distribution of the area.

For a site containing above average wind velocities, optimal generator size may be about 2500 watts per square meter of kite collection area. The optimal amount of power to be harnessed may be some amount lower than the peak power generated by the wind in a region. Optimization may be simplified by minimizing the cost/power ratio given the cost of the kite, rope, and generator necessary to harness a given power and the wind power available in a specific region.

In an exemplary embodiment where the average wind power for an area is 400 watts/m² and the peak power is 4000 watts/m², the maximum power able to be harnessed may be set at 1000 watts/m². Cost per area for kite may be fixed at approximately $50/m². Cost per area for rope may be length (800 m*240 N of force/m@1000 watts*$0.000058/m/N=$11.14/m². Cost per generator may be $0.05/watt=$50/m². This gives a cost of $111.14/m². One may then calculate using the actual amount of energy that could be generated by this system and may calculate the amount money generated per area. The number may then be recalculated for increased generator and rope sizes. The optimal number maximizes the ratio of profit/cost per area.

In the instantaneous mechanical model, the impact of the wind against the kite may be approximated as a series of elastic collisions. In this case, energy transfer to the kite may be maximized when the kite may be moving at 50% of wind speed, and transfer efficiency may be 100%. However, other methods may be used to more accurately optimize the entire system. Once kite speed increases above zero, the rate of molecular impacts onto the surface decreases. Taking this into account, a more accurate calculation maximizing the force on the kite times the kites outbound speed indicates an optimal kite speed equal to ⅓ (33%) wind speed.

Stability and predictability in the system are important when optimizing the system. Extraction at ˜33% of the wind speed optimizes simple mechanical power generation. Smooth operation however provides both power generation and stability. Therefore several methods are used to give smooth operation at approximately 33% extraction, such as an active generator. An active generator may vary resistance with changes in wind speed, and spikes in wind as discussed before. Also, operating at the currently disclosed altitude largely reduces turbulence issues associated with the boundary layer of fluid flow.

Safety may be another important consideration in the present embodiment. Minimizing dangers to persons around the system, the environment, and to the system itself are all addressed to maximize cost efficiency and minimize risks.

Static electricity and lightning strikes are going to be important safety considerations, and likely may be common with the system. Several features may be included in the system to prevent danger to humans, equipment, and the grid. First, the kite may be made of poorly conductive and flame retardant materials. Second, the lines may be poorly conductive as well; this may ensure that any lightning that strikes the kite may not be transferred to the ground via the lines. The power/generating equipment may also be separated from the kite anchor, and use insulated mechanical devices (gears, shaft, etc.) to connect to the anchor. Prior to sensitive electrical equipment, lines may be attached to a grounding system, which may effectively operate as a lightning rod and grounds the circuit.

There are several other safety measures designed into the system. First, a fault line may be used to prevent catastrophic failure during high winds or gusts. The fault line may be designed to be the weakest line, and may break first in the event of excessive wind force. Without the fault line, the kite may no longer produce enough lift to continue operation, at which time emergency winding may occur. The kite may be able to sustain enough lift for the kite to be recovered without crashing.

A similar method may be used in the case of unexpected lull in winds. In an exemplary embodiment, the system may operate within the wind speed range of 2 m/sec to 20 m/sec. However, if the wind decreases to 0.5 m/sec, then the generator may wind the system in at 1.5 m/sec. This may give the system the required 2 m/sec wind to create appropriate lift while retraction occurs, and may prevent the kite from crashing. Additionally, winding in the kite reduces the weight of the expended line, decreasing the minimum wind speed for the kite.

Another safety measure may be automatic adjustment of the kite to prevent shock failure. The kites may be able to flatten in the event of a wind spike, or gust, and then be able to recover previous shape to continue operation. This again may prevent crashes.

As well, the equipment on the ground may have safety measure to prevent failure. Besides the before mentioned insulation, the generator may have the ability to slip to adjust to unsafe events. This may reduce the tension on the lines, and the torque on the anchoring system. Force on the kites may also lessen.

Related prior art of the present disclosure do not address many of the difficulties of wind powered energy generation. Namely the complexity of controlling the system, and inefficiencies in the system. Weight may be a major concern, and most of the weight in a system may be in the lines and ropes. Therefore minimizing the number of lines and ropes may increase the system's efficiency. Prior art does not address the materials and methods to be used to fix this problem.

A second way to decrease weight and increase cost effectiveness may be to simplify the system. For example, U.S. Pat. No. 6,523,781 and U.S. Pat. No. 7,188,808 must have fully rotatable housing platforms. This housing platform must contain the gearing system, the generator, and anchoring systems, making it a substantial engineering feat. The present disclosure eliminates the need for a large housing platform by its robust vertical axis with fully circular spool. In this way the wind may blow any direction, and the large components (gearing system, generator, etc.) do not need to move.

Secondly, prior art always has a way to decrease the effectiveness to prevent damage to the system, such as U.S. Pat. No. 6,523,781 changes the pitch angle and release rate of the lines to stay within in a range that the system may handle. The present disclosure improves on the system by using this energy in other ways, and still safely operating. With the increased strength of materials used in the kite, the stresses of higher wind speeds are expanded, and instead of dissipating the energy, the present system utilizes other properties such as a clutch and a flywheel to use the extra energy in a different way. This ability to convert excess energy increases the overall efficiency of the present embodiment.

Many of the prior art require inflation of components of their systems with “lighter than air” gases to help create lift and sustain flight. The present disclosure does not require such features, nor the technology required to give the system that capability. There exist many modes of failure and added complexity associated with the ability to pump a gas along a suspended line. Secondly, several hundred feet of tubing required to transport the gases from the ground to the launched system may add weight to the system, further decreasing its efficiency. U.S. Pat. No. 6,523,781 solves this problem by permanently inflating the airfoil. However, permanent inflation in a dynamic environment could require extensive maintenance, and has the risk of failure. The failure places the entire system at jeopardy, as well makes the area around the system unsafe.

The present disclosure solves many of the engineering conflicts of prior art by using new materials not previously available, and simplifying their use into an efficient system.

The structural and operational features and functions described herein for sustainable, efficient, and consistent wind power generation may be implemented in various manners. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

1. A system for harnessing power from wind using a wind capturing structure lofted into optimal wind currents comprising:
a wind capturing structure for creating a force operable over a variable wind range of approximately 3 [m/sec] to wind in excess of at least 15 [m/sec];
at least one line of maximized strength to density ratio attached to said wind capturing structure for generating linear motion;
an axis of rotation upon which said plurality of lines wrap about said axis of rotation for optimal directional freedom;
a winding structure on said axis of rotation upon which said plurality of lines wrap about said axis of rotation for transferring said linear motion into rotational motion;
a retractor attached to said winding structure on said axis of rotation for rewinding said plurality of lines from one predetermined length to a second predetermined length of shorter magnitude;
a generator, compressor, pump, flywheel or any energy producing or storage device coupled to said winding structure for converting said rotational motion of the winding structure on said axis of rotation upon which said plurality of lines wrap about said axis of rotation for generating power.

2. The system for harnessing power from wind of claim 1, wherein said wind capturing structure may be a structure from the group consisting essentially of a kite, a sparless kite, a bridleless kite, a single skin kite, a parawing kite, a sail wing kite, a Rogallo kite, a low line angle kite, a high angle of attack kite, and a low lift/drag ratio kite.

3. The system for harnessing power from wind of claim 1, wherein said wind capturing structure comprises a structure for creating lift in a low wind environment.

4. The system for harnessing power from wind of claim 1, wherein said wind capturing structure comprises a structure for operating in high wind conditions.

5. The system for harnessing power from wind claim 1, wherein said at least one line associates for harnessing said wind capturing structure.

6. The system for harnessing power from wind of claim 1, wherein said at least one line associates for preventing slippage of said wind capturing structure.

7. The system for harnessing power from wind of claim 1, wherein said at least one line comprises material with a strength to density ratio of at least approximately 250 [kN*m/kg].

8. The system for harnessing power from wind of claim 7, wherein said at least one line comprises material formed from at least one material from the group consisting essentially of carbon nanotubes, carbon fiber, UHMWPE synthetic rope, Cuben Fiber, Plasma, PBO, Kevlar, Aramid, M5, Zylon, and Braid Optimized for Bending (BOB), a hybrid rope, or any other material with a strength to density ratio of at least 250 [kN*m/kg].

9. The system for harnessing power from wind of claim 1, wherein said lines harnessing said wind capturing structure are constructed with minimal mass per kite area of less than approximately 0.25 Kg/m² for lifting said wind capturing structure in low wind conditions.

10. The system for harnessing power from wind of claim 1, wherein said lines harnessing said wind capturing structure are constructed with a specific strength of at least approximately 250 kN*m/kg to prevent failure in high wind environments.

11. The system for harnessing power from wind of claim 1, wherein said winding structure may be a spool, spindle, reel, coil, or any structure capable of rotating about an axis.

12. The system for harnessing power from wind of claim 1, wherein a clutch or a gearing system may be associated with said winding structure for transferring linear motion into rotational motion using said retractor for rewinding said at least one line.

13. A versatile wind capturing structure operating in variable environments with consistent force generating capacity comprising:
a kite operable in variable conditions for efficient and consistent production of said force;
at least one line of maximized strength to density ratio operable on said kite operable in variable conditions for control and said linear motion generation;
velocity controller for controlling said rotational motion and said linear motion;
drag controller for adapting said kite for optimizing power output and/or input.
a versatile wind capturing structure adaptable by said drag controller and said velocity controller and operable by said plurality of lines for efficient and consistent force generating capacity.

14. The wind capturing structure of claim 13, wherein said kite may be a sparless kite, a bridleless kite, a single skin kit, a parawing kite, a sail wing kite, a Rogallo kite, a low line angle kite, a high angle of attack kite, a low lift/drag ratio kite, or any other kite capable of sustained flight.

15. A wind capturing structure of claim 13, wherein said velocity controller may comprise altering a load upon a generator.

16. A wind capturing structure of claim 13, wherein said method of controlling velocity of flight comprise altering lift and/or drag forces of said versatile wind capturing structure.

17. A wind capturing structure of claim 13, wherein said drag controller may comprise folding, deforming, re-orienting, or any other means of reducing lift and/or drag acting on said wind capturing structure.

18. A method for a power producing cycle of a system generating power from wind using a wind capturing structure lofted into optimal wind currents comprising the steps of:
unwinding of a winding structure by at least one line in linear motion for producing rotational motion;
coupling of said winding structure to a generator for optimal power production;
controlling the velocity of said linear motion for maximizing power production;
ceasing extension by a velocity controller of said linear motion of said at least one line for ending extension at upper bound of the optimal environment;
adapting said wind capturing structure by a drag controller for decreasing lift and/or drag force on said wind capturing structure;
altering said winding structure to operate in a reverse direction for winding of said at least one line;
winding said winding structure with minimal input energy for returning wind capturing structure to the lower bound of said optimal environment;
adapting said wind capturing structure by said drag controller for increasing lift and/or drag force on said wind capturing structure;
altering the winding structure for unwinding said at least one line in linear motion reproducing said rotational motion for completing said power producing cycle of a system generating power from wind power using a wind capturing structure lofted into optimal wind currents.

19. The method for a power producing cycle of a system generating power from wind of claim 18, wherein step of unwinding of a winding structure by said at least one line in a linear motion occurs with minimal slipping.

20. The method for a power producing cycle of a system generating power from wind of claim 18, wherein said controlled velocity may be accomplished by altering the load upon a generator.

21. The method for a power producing cycle of a system generating power from wind of claim 18, wherein said controlled velocity may be accomplished by altering the lift and/or drag forces on said wind capturing structure.

22. The method for a power producing cycle of a system generating power from wind of claim 18, wherein said decreasing lift and/or drag force on said wind capturing structure further comprises folding, deforming, re-orienting, or any other means of reducing lift and/or drag occurring with said wind capturing structure.

23. The method for a power producing cycle of a system generating power from wind of claim 18, wherein said retracting of said wind capturing structure further comprises retracting of said wind capturing structure with less energy than may be produced by said conversion of rotational motion into energy.
